(19) United States
(12) Patent Application Publication
(10) Pub. No.: US 2007/0034237 A1
(43) Pub. Date: Feb. 15, 2007

(54) Parts washer method

(76) Inventor: David L. Stockert, New Boston, MI (US)

Correspondence Address: HARNESS, DICKEY & PIERCE, P.L.C., P.O. BOX 828, BLOOMFIELD HILLS, MI, 48303, US

(21) Appl. No.: 11/582,279

(22) Filed: Oct. 17, 2006

Related U.S. Application Data
(62) Division of application No. 10/342,977, filed on Jan. 15, 2003, now Pat. No. 7,146,991.
(60) Provisional application No. 60/351,296, filed on Jan. 23, 2002.

(51) Int. Cl. B08B 9/00; B08B 7/04; B08B 7/00; B08B 3/00

(52) U.S. Cl. 134/18; 134/22.1; 134/33; 134/166 R; 134/56 R

(57) ABSTRACT

A parts washer system includes a cleaning fluid and a sensor. In another aspect of the present invention, an industrial parts washer includes a housing, a conveyor, a cleaning solution and a particle detector. Still another aspect of the present invention employs a controller which is operable to stop the cleaning of an industrial part if a debris-to-cleaner ratio reaches a target value.

### CROSS REFERENCE TO RELATED APPLICATIONS

This application is a divisional application of U.S. patent application Ser. No. 10/342,977, filed Jan. 15, 2003, which claims the benefit of U.S. Provisional Patent Application Ser. No. 60/351,296, filed Jan. 23, 2002, both of which are incorporated by reference herein.

### BACKGROUND OF THE INVENTION

The present invention relates generally to industrial machinery and more specifically to a parts washer system.

Industrial parts washers are commonly used to remove debris, such as machining burrs, grease and dirt, from metallic parts such as engine blocks and crankshafts. Two such conventional devices are disclosed in Canadian Patent No. 669,262 entitled “Washing Apparatus” which issued to Umbricht on Aug. 27, 1963, and United Kingdom Patent No. 817,851 entitled “Improvements in or Relating to Washing Apparatus” which was published on Aug. 6, 1959. Another known industrial parts washer is disclosed in U.S. Pat. No. 3,059,861 entitled “Adjustable Spray Nozzle Assembly” which issued to Umbricht et al. on Oct. 23, 1962, and is incorporated by reference herein. Many traditional industrial parts washers typically flow a cleaning liquid onto the part for a predetermined period of time regardless of how clean the part actually is and regardless of part-to-part variability. Thus, the historical worst case scenario is commonly used to define the future predetermined period for cleaning which often leads to a sometimes slower than necessary process even for parts which are relatively clean after the prior machining operations.

Other cleaning devices are known in different industries as disclosed, for example, in the following U.S. patent application and patents: US 2001/0015096 A1 entitled “Monitoring of Particulate Matter in Water Supply” which was published on Aug. 23, 2001; U.S. Pat. No. 5,647,386 entitled “Automatic Precision Cleaning Apparatus with Continuous On-Line Monitoring and Feedback” which issued to Kaiser on Jul. 15, 1997; and U.S. Pat. No. 5,560,060 entitled “System and Method for Adjusting the Operating Cycle of a Cleaning Appliance” which issued to Dausch et al. on Oct. 1, 1996; all of which are incorporated by reference herein. These conventional devices, however, appear to have little application in the industrial parts industry for cleaning machining burrs and manufacturing plant dirt, especially for large parts having long internal passageways.

### SUMMARY OF THE INVENTION

In accordance with the present invention, a parts washer system includes a cleaning fluid and a sensor. In another aspect of the present invention, an industrial parts washer includes a housing, a conveyor, a cleaning solution and a particle detector. Still another aspect of the present invention employs a controller which is operable to stop the cleaning of an industrial part if a debris-to-cleaner ratio reaches a target value. A method of operating a parts washer is also provided.

The present invention is advantageous over conventional machines in that the present parts washer easily determines the cleanliness of an industrial part in a non-obtrusive and real time manner. Thus, the cleaning cycle can vary from part-to-part as needed. Accordingly, cleaning quality is improved for parts having excessive burrs and debris while cycle time is quickened for relatively clean parts. The present invention thereby improves overall processing speed and quality while reducing traditional energy costs to run the process based on average or worse case times. Additional advantages and features of the present invention will become apparent from the following description and appended claims, taken in conjunction with the accompanying drawings.

### BRIEF DESCRIPTION OF THE DRAWINGS

FIG. 1 is a diagrammatic view showing the preferred embodiment of a parts washer system of the present invention;

FIG. 2 is a perspective view showing a portion of the preferred embodiment parts washer system;

FIG. 3 is a side elevational view showing a portion of the preferred embodiment parts washer system;

FIG. 4 is a perspective view, adjacent a part entry, showing a portion of the preferred embodiment parts washer system;

FIG. 5 is a perspective view, adjacent a top corner, showing a seal and flush mechanism employed in the preferred embodiment parts washer system;

FIG. 6 is a side diagrammatic view showing the seal and flush mechanism employed in the preferred embodiment parts washer system, with the mechanism in a raised position;

FIG. 7 is a side diagrammatic view, like that of FIG. 6, showing the seal and flush mechanism employed in the preferred embodiment parts washer system, with the mechanism in a closed position;

FIG. 8 is an end diagrammatic view showing the seal and flush mechanism employed in the preferred embodiment parts washer system, with the mechanism in a raised position;

FIG. 9 is a diagrammatic top view showing a first alternate embodiment of the parts washer system of the present invention;

FIG. 10 is a diagrammatic top view showing a second alternate embodiment of the parts washer system of the present invention; and

FIG. 11 is a diagrammatic top view showing a third alternate embodiment of the parts washer system of the present invention.

### DETAILED DESCRIPTION OF THE PREFERRED EMBODIMENTS

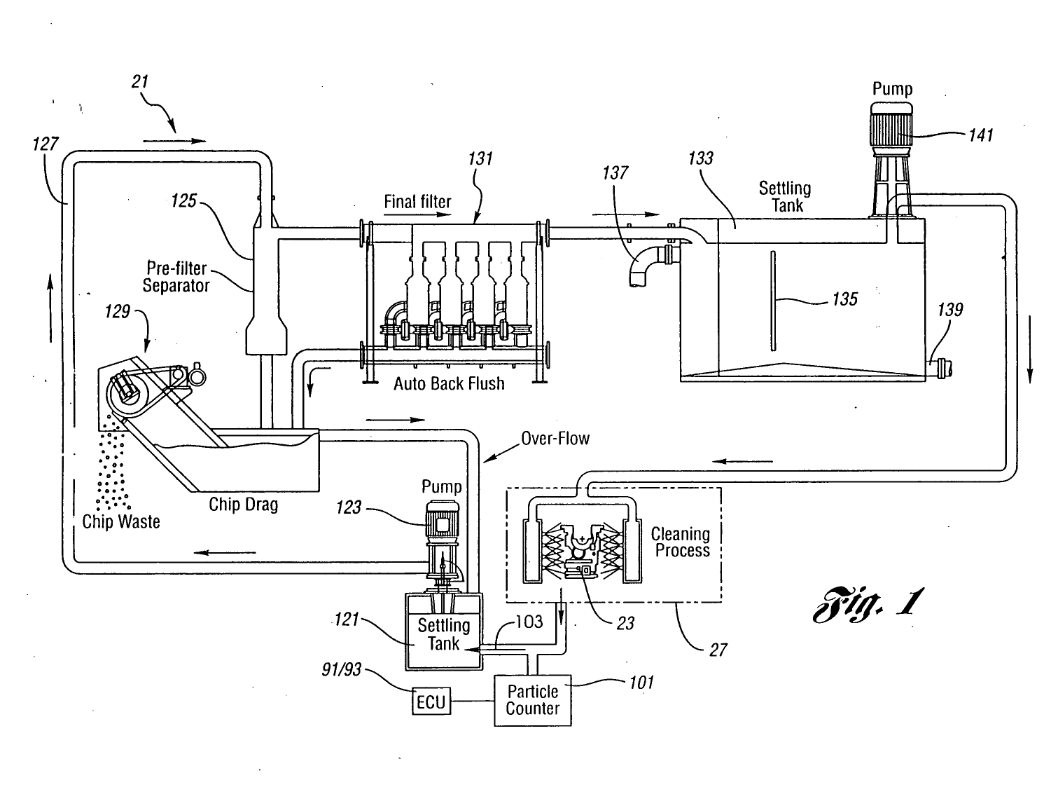

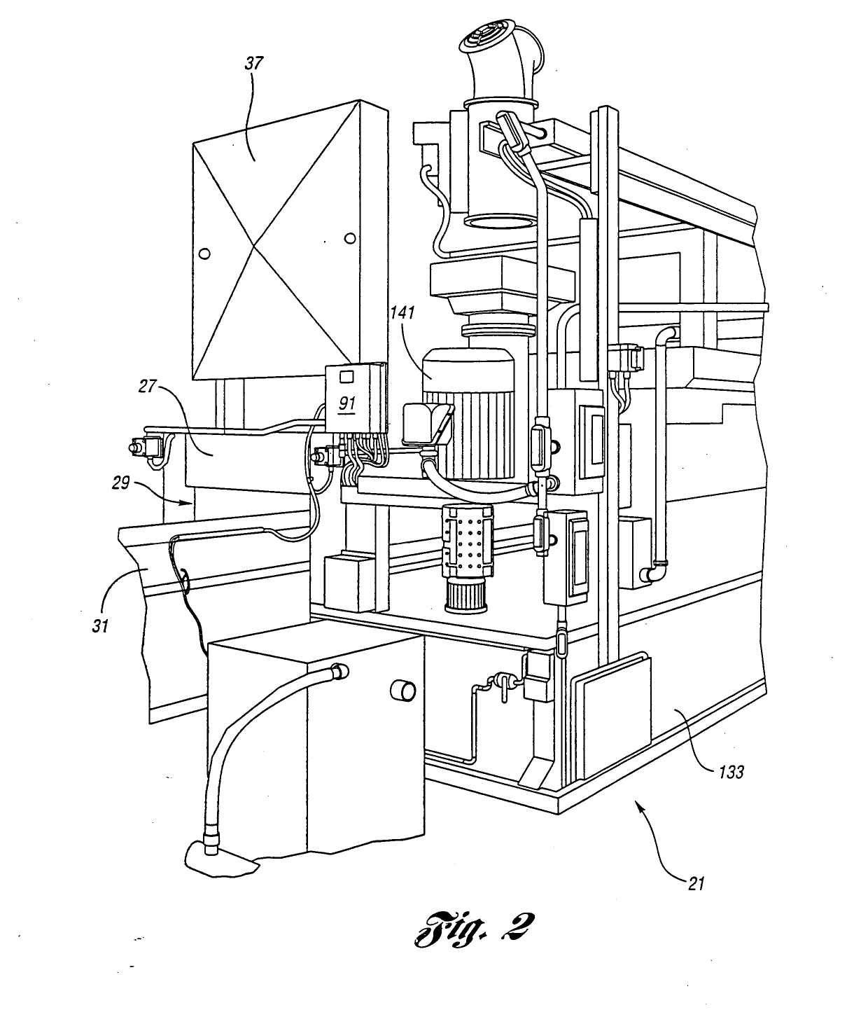

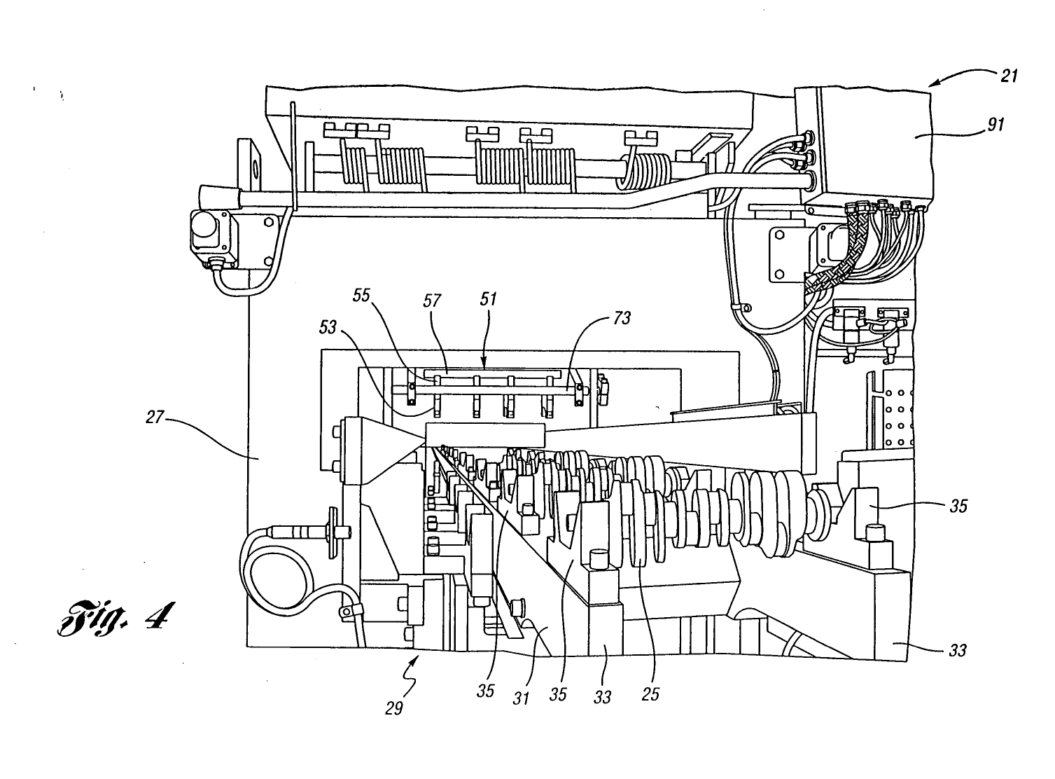

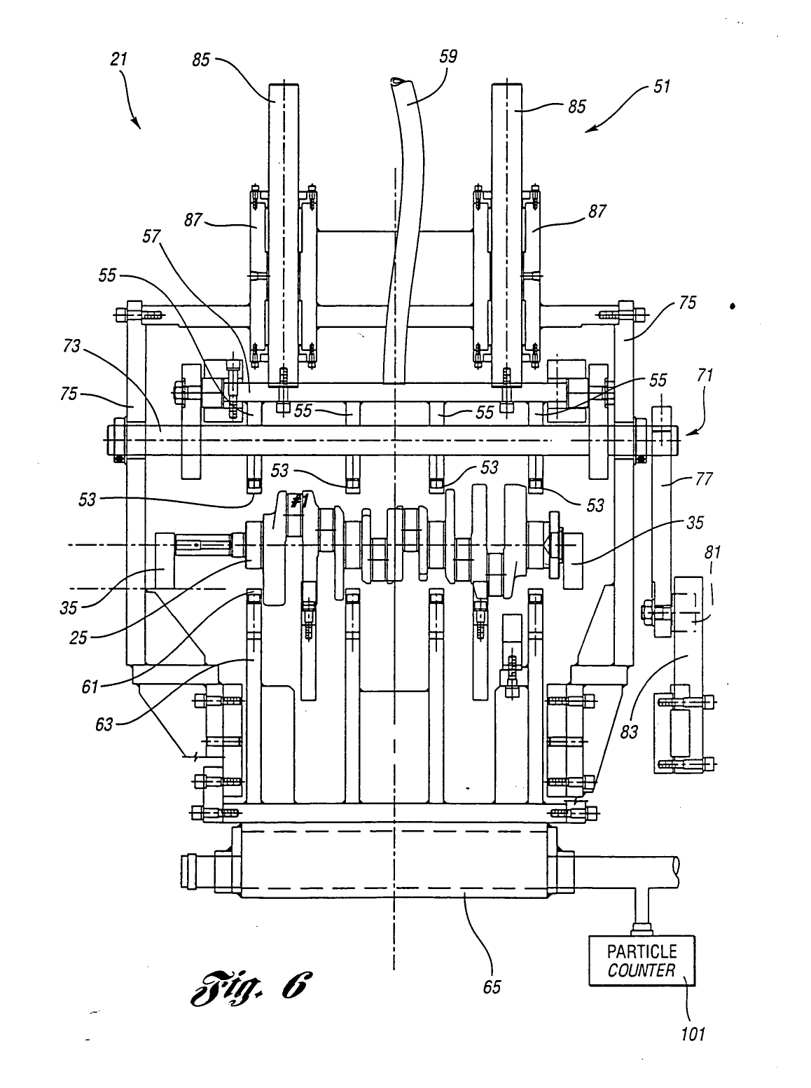

Referring to FIGS. 1, 2, 4 and 6, the preferred embodiment of a parts washer system 21 is used in an industrial manufacturing plant to clean machining burrs, grease, dirt and other manufacturing debris from industrial parts or workpieces such as automotive vehicle powertrain components, including an engine block 23 (see FIG. 1), a metallic crankshaft 25 (see FIGS. 4 and 6), or the like. Parts washer system 21 operates as a cleaning station after a machining station (not shown) where the part has elongated internal passageways or other features added by a milling machine, lathe, or similar automatic tools. Parts washer system 21 includes a sheet metal housing 27 affixed to the factory floor. Housing 27 essentially encloses the parts cleaning station yet has an entryway 29 for allowing access entry and exit by a horizontally moving shuttle 31 or other type of automatically operating conveyor. Shuttle 31 has a pair of parallel rails 33 upon which are mounted spaced apart perches 35 for carrying a set of parts 25 into the housing. A vertically movable access door (shown in a raised position in FIG. 2) is lowered after shuttle 31 moves inside housing 27.

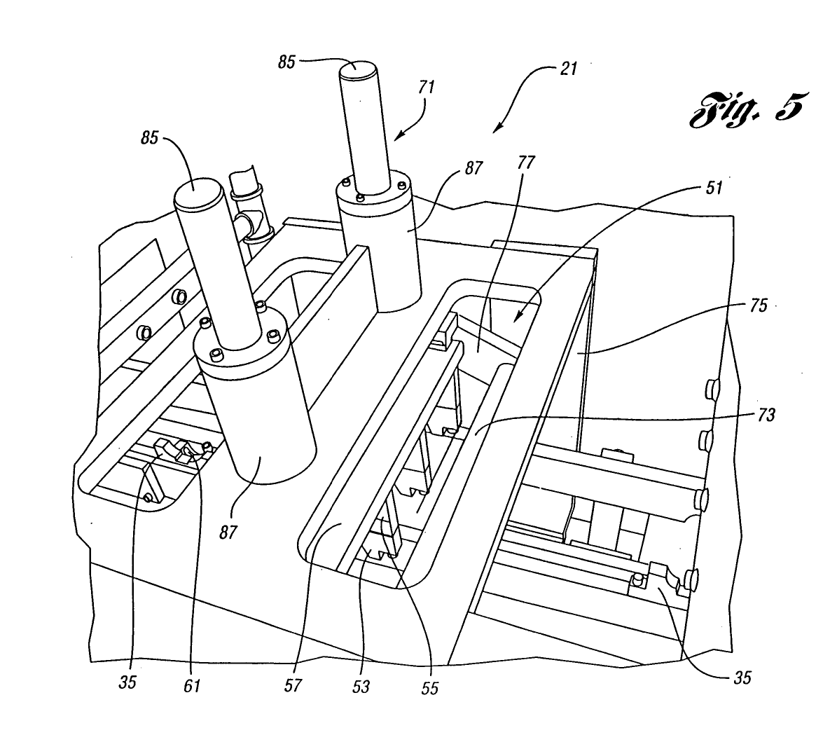

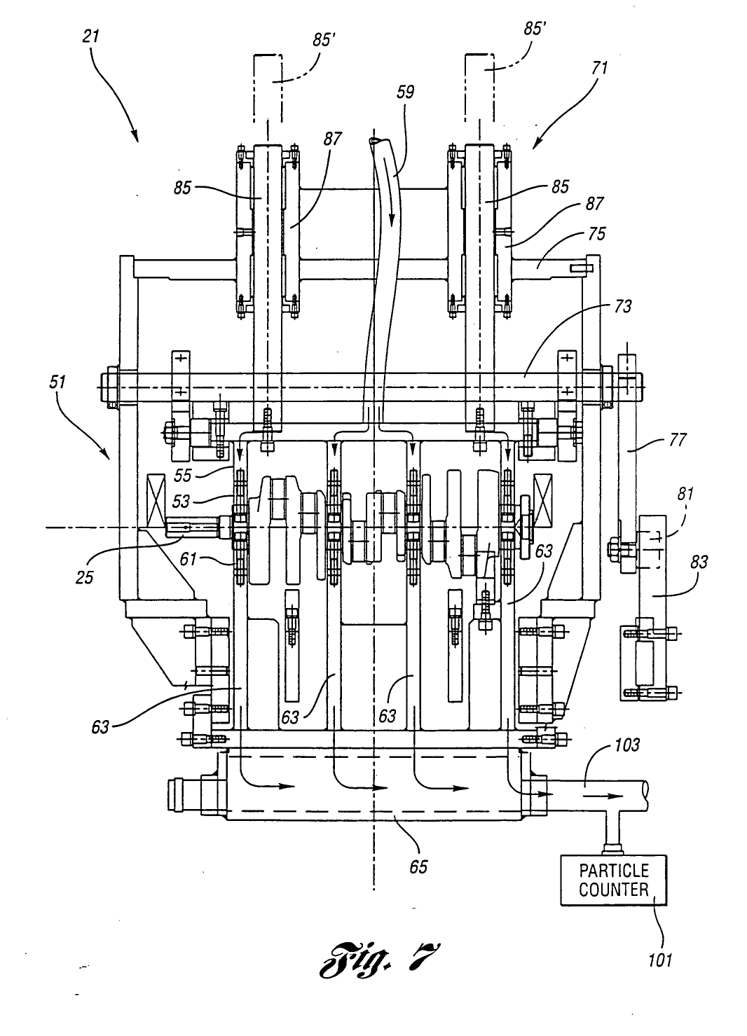

FIGS. 4-8 show the internal components of parts washer system 21 for use with the crankshaft-type parts 25. A programmable logic controller (“PLC”) first causes shuttle 31 to be automatically moved inside housing 27 to align each part 25 with a corresponding seal and flush unit 51. Seal and flush unit 51 includes a set of offset and parallel upper seals 53 having a generally semi-circular contacting surface shape made from a polymeric material such as polypropylene, polyurethane or nylon. Each upper seal 53 is affixed to a seal support 55 which has hollow bores to allow for internal fluid flow from an attached upper manifold 57. A flexible in-flow pipe or hose 59 is coupled to upper manifold 57 whereby clean washing fluid sequentially flows through in-flow pipe 59, through upper manifold 57, through seal supports 55, around a concave cross-sectional channel within the semi-circular contacting surface of each upper seal 53, which then contacts and seals against an upper matching surface of part 25. Each seal and flush unit 51 further includes a set of lower seals 61 and hollow seal supports 63 which are all in communication with and coupled to an outflow manifold 57. Lower seals 61 serve to collect the washing fluid that has been transmitted through the outside surface and internal passages in part 25 and then transfer the now dirty washing fluid to the outflow manifold 65.

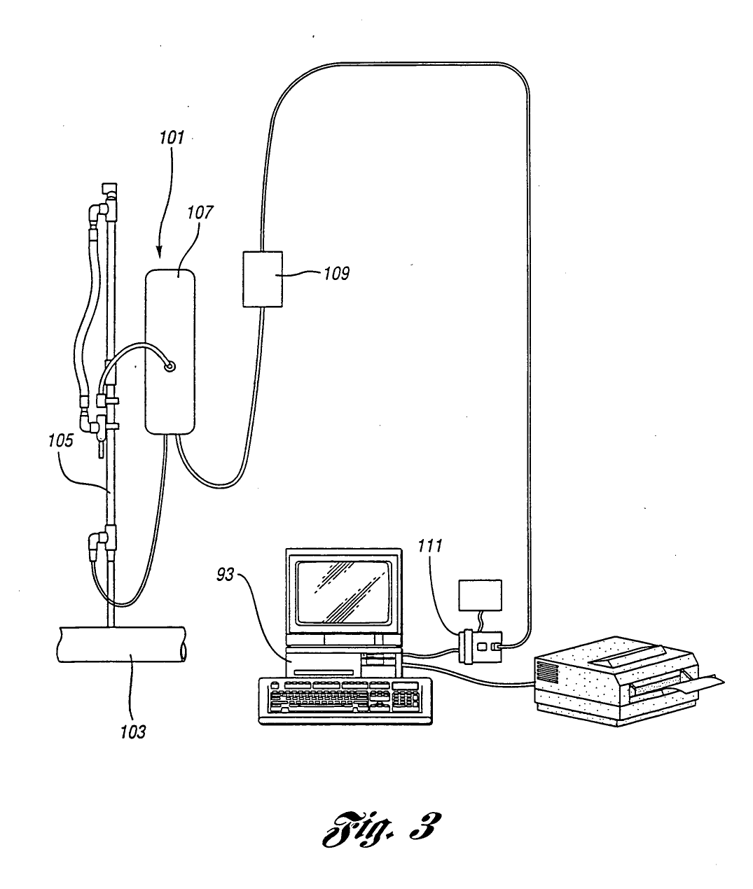

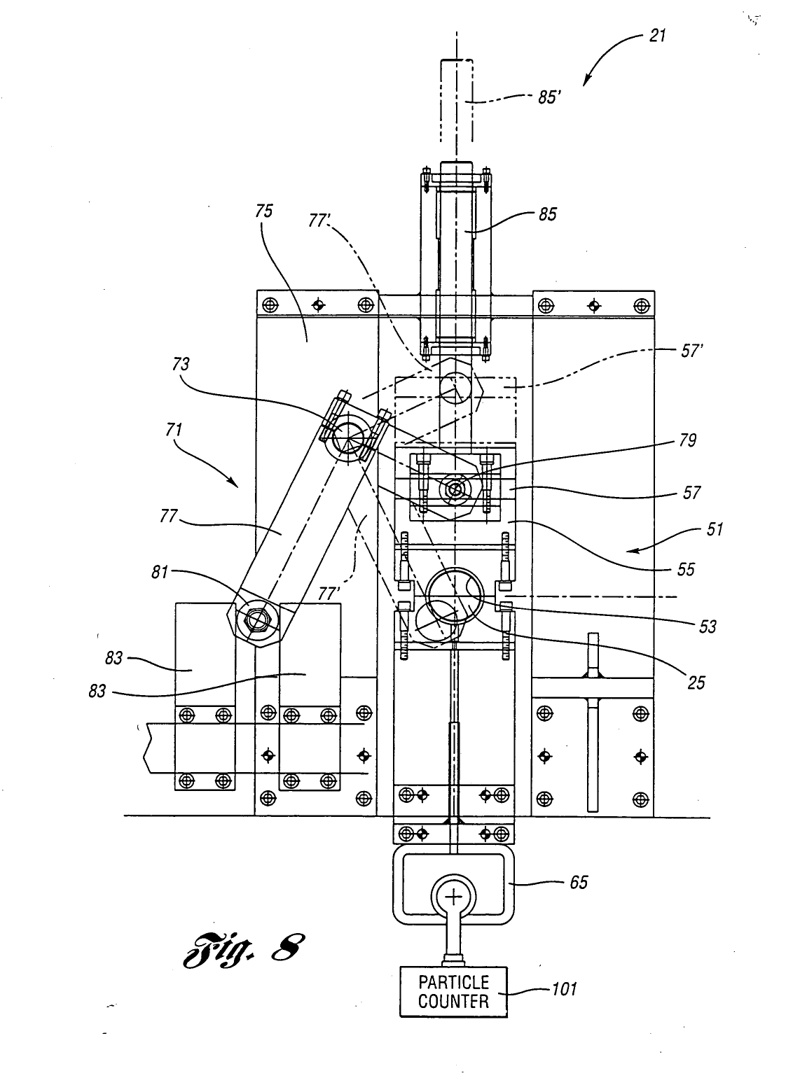

A movement mechanism 71 employs a pivot bar 73 which is rotatably fixed to a frame 75, stationary relative to housing 27. An L-shaped arm 77 is rotatably cantilevered about pivot bar 73 at its elbow, and has a first end pivotally coupled to upper manifold 57 at a first pivot 79. A roller 81 is coupled to an outside of an opposite end of arm 77 and is located between two upstanding structures 83 which are fastened to one of the rails 33 of shuttle 31. Furthermore, guide pins 85 vertically slide within upstanding collars 87 affixed to a top wall of frame 75 in order to assist in accurate movement of the upper segment of seal and flush assembly 51. Accordingly, normal movement of shuttle 31 and parts 25 from the initial loading position external to housing 27, to the washing position aligned with seal and flush assembly 51 internal to housing 27 (parts 25 moving from right to left as shown in FIG. 8), causes structures 83 to rotate arm 77 about pivot bar 73 thereby lowering upper manifold 57 and the attached upper seals 53 to contact against part 25. A proximity or other electrical switch senses that seal and flush assembly 51 has engaged parts 25, whether directly or indirectly, and an appropriate signal is sent to the attached programmable logic controller 91 or other electrical control unit, such as a micro processor based personal computer controller 93 (see FIG. 3); the controller subsequently causes the cleaning process to begin by operating a set of motors and pumps to begin the flow of cleaning fluid.

Reference should now be made to FIGS. 1, 3, 7 and 8. A particle counter-type turbidity sensor 101 is coupled to an outflow pipe 103 which is, in turn, coupled to a downstream end of outflow manifold 65. One satisfactory particle counter sensor 101 is a model 215W Liquidborne Laser particle counter which can be obtained from Met One of Grants Pass, Oreg. Such a particle counter sensor includes a water weir flow controller 105, a sensor 107, an electrical module 109 for power and communications, an adapter 111, personal computer 93 for real-time sensing, data processing, storing and outputting particle counting data from the out flowing cleaning fluid and for comparing the actual sensed readings to either predetermined targets (representing a satisfactory cleaning fluid value or range) or previously sensed values thereby optimizing and controlling each washing cycle based on these real-time sensed values relative to the target values. In other words, the parts washer system performs by: (a) removing debris from a first machined workpiece by washing the first workpiece with a cleaning liquid; (b) sensing the cleanliness of the solution after workpiece washing; (c) communicating a signal of the sensed value to an electronic control unit; (d) automatically comparing the signal to a predetermined or target value; (e) determining the amount of debris in the liquid; (f) removing at least some of the debris from the liquid; (g) automatically varying a fluid flow characteristic of the liquid if the sensed value is substantially the same or different as compared to the predetermined value, wherein the characteristic includes, but is not limited to, re-using the liquid to subsequently remove debris from the same workpiece if the values are different, or automatically terminating the fluid flow and cleaning of the first workpiece if the sensed value of the liquid reaches the target debris-free value; (h) automatically removing the workpiece from the washer if the sensed value is substantially the same as the predetermined value; and (i) re-using the liquid to subsequently remove debris from additional workpieces. Furthermore, computer 93 stores, calculates and outputs historical statistical trends based on sensed cleaning fluid readings; this can include standard deviation and averaging calculations. Additionally, computer and particle counter sensor 101 can provide an output as to the filtering success for various desired time periods for the recycled cleaning fluid, in order to inform the operator as to when filter cleaning, cleaning fluid disposal or other maintenance may be desired in order to further optimize the process. The computer and particle counter sensor are further able to sense and calculate the cleanliness of the prior machining operations through sensed values and even if part aperture blockages have occurred as will be discussed in more detail with various of the alternate embodiments.

FIG. 1 shows the remainder of the parts washer system 21 fluid flow outside of the housing. A “dirty” settling tank 121 is connected to the downstream end of outflow pipe 103. A motor and pump 123 serve to pump cleaning fluid from tank 121 to a pre-filter separator 125 by way of another pipe 127. Pre-filter separator 125 employs an approximately 75 micron filtering system. Machining chips, debris and other settled out or filtered out particulate matter is then moved and discarded by way of a conventional chip drag and chip waste mechanism 129. A final filter assembly 131 is disposed downstream of pre-filter separator 125 to further filter out undesired particles and debris from the cleaning fluid by use of an approximately 50 micron filtering system. Final filter assembly 131 includes a media filter while pre-filter 125 employs a centrifugal filter. A “clean” settling tank 133 is located downstream of final filter assembly 131 and further allows for holding of the cleaning fluid for subsequent washing while allowing some additional particulate settling. Settling tank 133 includes a weir 135, an overflow pipe 137 and a cleaning drain 139. Another pump and motor 141 serve to flow the cleaning fluid from settling tank 133 to the part washing station within housing 27 when energized by the controller. It should be appreciated, however, that many other filtering and settling components can be used in place of or in addition to those disclosed herein. Notwithstanding, it is highly desirable to employ a closed loop and recyclable cleaning fluid system in order to reduce disposal costs and to save on cleaning fluid expense. The cleaning fluid is preferably a water borne, alkaline liquid solution containing a degreaser and a detergent. It is also envisioned that an electrolyte solution including disodium phosphate, sodium bicarbonate and water can be employed; such a solution is disclosed in U.S. Pat. No. 6,264,823 entitled “Non-Caustic Cleaning of Conductive and Non-Conductive Bodies” which issued to Hoffmann, Jr. et al. on Jul. 24, 2001, and is incorporated by reference herein.

Only a single particle counter sensor is needed, thereby saving equipment cost and reducing controller processing speed requirements, however, it is alternately envisioned that a second particle counter sensor located upstream of the part to be washed can be used in addition to the downstream particle counter sensor 101 in order to allow a more direct comparison calculation of real-time sensed fluid value measurements by the controller without possible variations caused by the closed loop system filters and tanks.

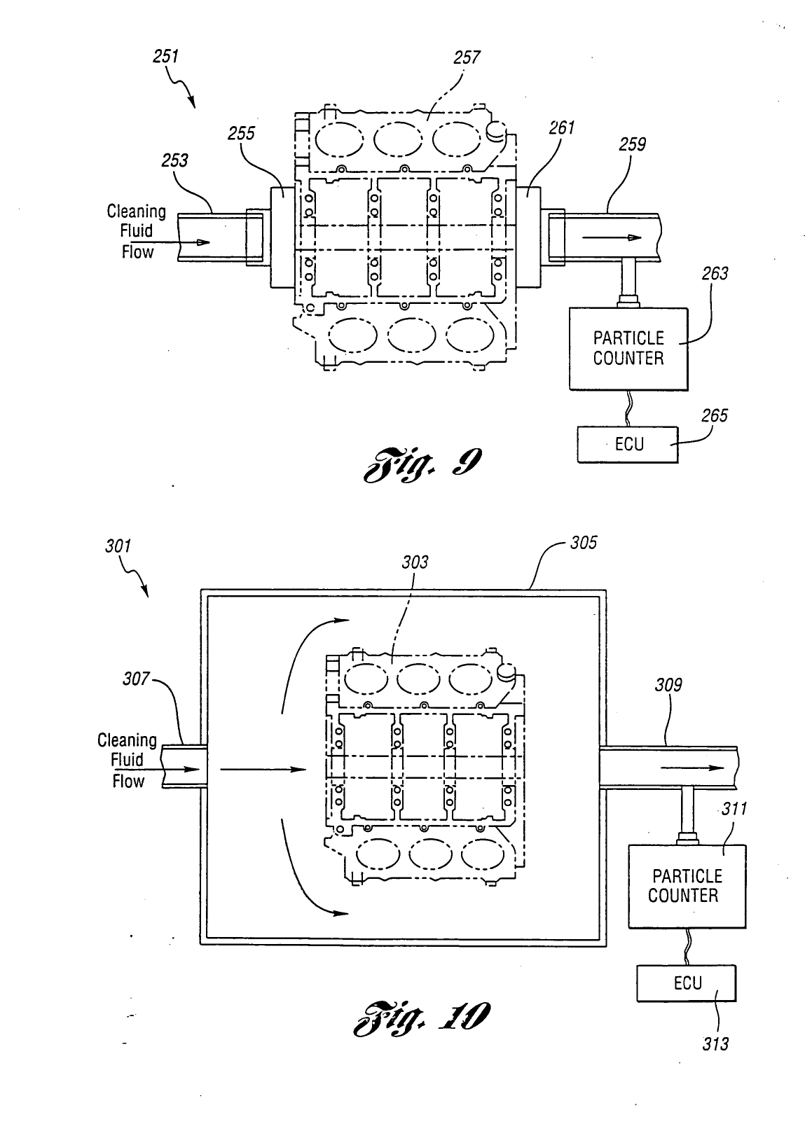

FIG. 9 illustrates a first alternate embodiment of a parts washer system 251 of the present invention. An in-flow pipe 253 and sealing unit 255 are automatically moved to contact and seal against a first side of an oil gallery, including a crankshaft bore, rocker arm paths, piston cylinder bores and the like, of an automotive vehicle engine block part or workpiece 257. At an opposite end of the oil gallery of engine block 257, an outflow pipe 259 and a corresponding sealing unit 261 are automatically moved to interface with part 257. This occurs within a housing of a parts washing station such as in the closed loop system of FIG. 1. A particle counter sensor 263 is coupled to outflow pipe 259 and an electrical control unit 265 is electrically connected to particle counter sensor 263. Thus, “clean” cleaning fluid automatically flows into the upstream side of part 257 and then exits as “dirty” cleaning fluid containing debris through outflow pipe 259. At this point, particle counter sensor 263 senses the concentration of debris within the cleaning fluid and sends a corresponding signal to controller 265 for processing of this information and comparing the real-time sensed values to the target cleaning fluid particulate concentration values in order to further control the cleaning cycle time.

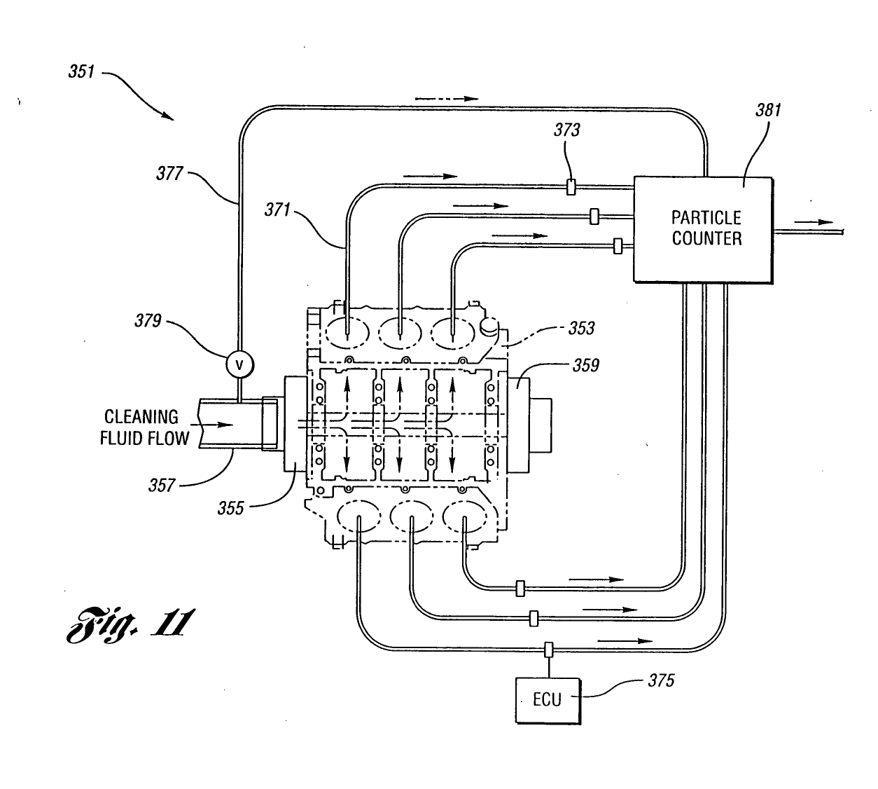

FIG. 10 illustrates a second alternate embodiment of a parts washing system 301 of the present invention wherein an engine block part or workpiece is fully immersed or submerged into a tank 305 essentially filled with cleaning fluid. The cleaning fluid automatically enters through an upstream inlet 307, flows through passageways in and completely around part 303, and then subsequently exits through an outlet pipe 309 coupled to a particle counter 311 and an electrical control unit 313.

A third alternate embodiment parts washing system 351 of the present invention is shown in FIG. 11. An engine block part 353 or the like is placed within a housing of a cleaning station wherein a first end is automatically contacted by a sealing unit 355 connected to an in-flow pipe 357. An opposite end of part 353 has a sealing plug unit 359 automatically attached. A set of outlet lines or tubes 371 is automatically moved to contact and seal against corresponding external openings such as piston cylinder bores, of part 353. A cantilevered movement mechanism such as that disclosed with the preferred embodiment can be employed to automatically move lines 371 relative to part 353. A flow sensor 373 is located within each line 371 to sense the volume, speed or pressure of fluid flowing through the corresponding line. An electrical control unit 375, connected to the flow sensors 373 compares the real-time flow sensor readings against either predetermined desired target values or against a baseline reading from a flow sensor mounted within a diversion line 377 located upstream of part 353. A diversion valve 379 allows for a diverted initial fluid flow through diversion line 377 at the beginning of each part cleaning cycle which may thereafter be shut off. The controller comparisons and calculations based on the flow sensor signals allow for an automatic and computerized determination of whether a blockage, such as by incomplete machining, is present in any internal passageway or aperture within part 353. This provides real-time and automated quality control checking on every manufactured part even in hidden internal and elongated passageways. A particle counter sensor 381 is also positioned downstream and connected to outlet lines 371 and 377. Particle counter sensor 381 is electrically connected to controller 375 to determine the concentration of debris or other undesired particles within the cleaning fluid to thereby automatically monitor and control the parts washing cycle for each part or batch of parts. It should be appreciated that the flow sensor inspection/monitoring, calculations and system control can be used independently of the particle counter sensor functions.

Various embodiments of the present invention parts washer system have been disclosed, however, it should be appreciated that other modifications may be made. For example, while a liquid cleaning fluid has been disclosed, air or other gaseous cleaning fluids can also be used. It should also be appreciated that other nonindustrial and nonautomotive parts can be employed with the apparatus of the present invention although some of the advantages of the present invention may not be achieved. Furthermore, movement mechanisms such as those using sprockets and chains, jackscrews, cams or gears can be used instead of or in addition to the cantilevered mechanism disclosed. Moreover, magnetic, optical or electrical sensors can be substituted in place of the particle counter sensor disclosed, although the performance may vary. While various materials have been disclosed, it should be appreciated that other materials may be employed. It is intended by the following claims to cover these and any other departures from the disclosed embodiments which fall within the true spirit of this invention.

The invention claimed is:

1. A method of operating an industrial parts washer, the method comprising:
(a) flowing fluid into an internal passage of an industrial part;
(b) automatically sensing a flow characteristic of the fluid; and
(c) automatically determining if the internal passage of the part is undesirably blocked, based at least in part on step (b).

2. The method of claim 1 further comprising washing the part substantially simultaneously with the flowing fluid step.

3. The method of claim 1 further comprising placing the part within a housing of a cleaning station in a manufacturing plant.

4. The method of claim 1 further comprising:
(a) automatically contacting an inlet end of the internal passage with a first sealing unit;
(b) automatically contacting an outlet end of the internal passage with a second sealing unit;
(c) flowing a liquid through lines connected to at least one of the sealing units; and
(d) sensing the flow characteristic with at least one sensor connected to at least one of the lines.

5. The method of claim 1 further comprising comparing a real-time sensor reading to a desired target value with an electrical control unit.

6. The method of claim 1 further comprising comparing a real-time sensor reading to a baseline reading with an electrical control unit.

7. The method of claim 1 further comprising automatically determining if an undesired blockage is present in the internal passage of the part which is an elongated passageway of an automotive vehicle powertrain component.

8. The method of claim 1 further comprising automatically determining if multiple connected passageways of an engine block are undesirably obstructed while washing manufacturing debris from the passageways.

9. The method of claim 1 further comprising automatically moving the part into and out of a cleaning station based on a real-time sensed computer determination of the cleanliness of the fluid.

10. A method of manufacturing and operating an industrial parts machine, the method comprising;
(a) connecting a sensor downstream of a passageway in an automotive vehicle powertain part;
(b) connecting an electrical controller to the sensor;
(c) connecting a fluid source upstream of the passageway in the part;
(d) supplying cleaning fluid to the passageway in the part;
(e) using the sensor to sense a characteristic associated with the fluid; and
(f) using the controller to calculate if the passageway is acceptably allowing passage of the fluid therethrough.

11. The method of claim 10 wherein the characteristic is fluid volume.

12. The method of claim 10 wherein the characteristic is fluid speed.

13. The method of claim 10 wherein the characteristic is fluid pressure.

14. The method of claim 10 wherein the characteristic is fluid flow.

15. The method of claim 10 further comprising washing the part substantially simultaneously with the flowing fluid step.

16. The method of claim 10 further comprising placing the part within a housing of a cleaning station in a manufacturing plant.

17. The method of claim 10 further comprising:
(a) automatically contacting an inlet end of the passageway, which is an internal passage, with a first sealing unit;
(b) automatically contacting an outlet end of the internal passage with a second sealing unit;
(c) flowing a liquid through lines connected to at least one of the sealing units; and
(d) sensing the flow characteristic with at least the sensor connected to at least one of the lines.

18. The method of claim 10 further comprising comparing a real-time sensor reading to a desired target value with the electrical controller.

19. The method of claim 10 further comprising comparing a real-time sensor reading to a desired target baseline reading with the electrical controller.

20. The method of claim 10 further comprising automatically determining if multiple connected passageways of an engine block are undesirably obstructed while washing manufacturing debris from the passageways.

21. The method of claim 10 further comprising automatically moving the part into and out of a cleaning station based on a real-time sensed computer determination of the cleanliness of the fluid.

22. A method of operating an industrial washer in a manufacturing plant to clean a workpiece, the method comprising:
(a) removing debris from a first machined workpiece by washing the first workpiece with a liquid;
(b) determining the amount of debris in the liquid after step (a);
(c) removing at least some of the debris from the liquid;
(d) re-using the liquid to subsequently remove debris from subsequent workpieces after step (c); and
(e) automatically terminating cleaning of the first workpiece if the liquid reaches a certain debris-free value.

23. The method of claim 22 further comprising sensing the quantity of debris in the liquid downstream of the first workpiece and before subsequent removal of debris from the liquid.

24. The method of claim 22 further comprising automatically moving the first workpiece into a machine which automatically applies the liquid upon the first workpiece.

25. The method of claim 22 further comprising automatically flowing the fluid through an internal passageway of the first workpiece which is an automotive powertrain component.

26. The method of claim 22 further comprising:
(a) sensing the cleanliness of the solution after workpiece washing;
(b) communicating a signal of the sensed value to an electronic control unit;
(c) automatically comparing the signal to a predetermined value;
(d) automatically varying a fluid flow characteristic of the liquid if the sensed value is substantially the same as the predetermined value; and
(e) automatically removing the workpiece from the washer if the sensed value is substantially the same as the predetermined value.

27. The method of claim 22 further comprising determining if an undesired obstruction is present in the workpiece based, at least in part, on a real-time sensed determination of a flow characteristic of the liquid.

28. A method of operating a parts washer, comprising:
(a) automatically moving a metallic workpiece into the washer;
(b) sensing the cleanliness of the solution after workpiece washing;
(c) communicating a signal of the sensed value to an electronic control unit;
(d) automatically comparing the signal to a predetermined value;
(e) automatically varying a fluid flow characteristic of the liquid if the sensed value is substantially the same as the predetermined value; and
(f) automatically removing the workpiece from the washer if the sensed value is substantially the same as the predetermined value.

29. The method of claim 28 further comprising automatically flowing the fluid through an internal passageway of the first workpiece which is an automotive powertrain component.

30. The method of claim 28 further comprising determining if an undesired obstruction is present in the workpiece based, at least in part, on a real-time sensed determination of a flow characteristic of the liquid.

31. The method of claim 28 further comprising:
(a) automatically contacting an inlet end of an internal passage of the workpiece with a first sealing unit;
(b) automatically contacting an outlet end of the internal passage with a second sealing unit;
(c) flowing a liquid through lines connected to at least one of the sealing units;
(d) sensing the flow characteristic with at least one sensor connected to at least one of the lines.

32. The method of claim 28 further comprising automatically determining if multiple connected passageways of an engine block are undesirably obstructed while washing manufacturing debris from the passageways.

33. An industrial system comprising:
a part having at least one internal passage;
a mechanism operable to flow fluid into an upstream end of the passage; and
a sensor connected to a downstream end of the passage;
wherein the sensor is operable to detect an undesired blockage in the passage by sensing a flow characteristic of the fluid.

34. The system of claim 33 further comprising:
a cleaning station;
a conveying assembly having a perch operable to hold the part and move it into the cleaning station in an automatic manner;
a substantially closed loop fluid flow system operably causing the cleaning fluid to contact the part and remove undesired particles;
a second sensor operably detecting the particles in the cleaning fluid; and
a controller connected to the sensors, the conveyor and the fluid flow system, the controller using an output signal from at least one of the sensors to determine if the part is acceptably clean at which point the controller varies the fluid flow system and causes the conveying assembly to remove the part from the cleaning station.

35. The system of claim 34 further comprising:
a seal;
a flushing device connected to the fluid flow system; and
a mechanism operable to automatically advance the seal and flushing device toward the part in the cleaning station, the seal operably contacting against the part.

36. The system of claim 33 further comprising:
an electrical control unit connected to the sensor, the control unit being operable to automatically change a fluid flow function;
the mechanism including a pump, an inlet pipe and an interface coupling the inlet pipe to the part.

37. The system of claim 33 wherein the part has multiple internal passages with a flow sensor connected to a downstream end of each passage.

38. The system of claim 33 wherein the fluid is a cleaning liquid with a detergent.

39. The system of claim 33 wherein the part is an engine block.
